(19) United States
(12) Patent Application Publication
(10) Pub. No.: US 2022/0268004 A1
(43) Pub. Date: Aug. 25, 2022

(54) Animal Design Toilet

(71) Applicant: Adolph Z. Guzman, Granada Hills, CA (US)

(72) Inventor: Adolph Z. Guzman, Granada Hills, CA (US)

(21) Appl. No.: 16/140,099

(22) Filed: Sep. 24, 2018

Related U.S. Application Data
(60) Provisional application No. 62/678,873, filed on May 31, 2018.

(51) Int. Cl. E03D 1/012; E03D 1/34; E03D 9/052

(52) U.S. Cl. CPC E03D 1/012; E03D 1/34; E03D 9/052

(57) ABSTRACT

An animal design toilet (ADT) that functions as a conventional toilet, but has the shape appearance of an animal such as a wolf. The ADT can be made in one of two designs, based on the ;type of animal. For certain animals it is possible to use an animal structure with both the upper body and lower body. For other animals, only the upper body including the head, neck and torso can be used. When only the upper body us sued, a base section is located below and supports the upper body. Other than the appearance of an animal, the ADT functions as a typical toilet and can be utilized and placed in any application or location increase a typical toilet would be. To increase the functions lights of the ADT, an odor reduction assembly can be implemented within the ADT. The assembly includes means to pull in odor and evacuate the odor from the ADT. Also, to add to the animal appearance effect, the animals can include lights that illuminate the eyes, and a sound assembly can provide audible noises/sounds such as a howl or roar form the animal structure.

### TECHNICAL FIELD

The invention generally pertains to household fixtures, and more particularly to a toilet that has an upper section with the appearance of an animal, and a built-in odor reduction assembly.

### BACKGROUND ART

Throughout the developed world one of the most ubiquitous hygienic devices is a toilet. By use of the toilet people can quickly, conveniently and hygienically discharge waste from their body and remove the waste from their vicinity. The toilet, in combination with utility sensor systems, allows human waste to then be sent to a treatment facility where the waste is processed to remove dangerous bacteria or other contaminants.

During the third millennium BC, toilets and sewers were invented throughout the world. Mohenjo-Daro circa 2800 BC is cited as having some of the most advanced, with toilets built into outer walls of homes. These toilets were Western-style, albeit a primitive form, with vertical chutes, via which waste was disposed of into cesspits or street drains.

Other very early toilets that used flowing water to remove the waste are found at Skara Brae in Orkney, Scotland, which was occupied from about 3100 BC until 2500 BC. Some of the houses there have a drain running directly beneath them, and some of these had a cubicle over the rain. Around the 18^{th} century BC, toilets started to appear in Minoan Crete, Pharaonic Egypt, and ancient Persia.

Although toilets have a function that has determined how a toilet is built, as well as the structural design, there have been attempts to provide toilets that have a unique appearance. The reasons for this is because some locations have custom designs and/or space requirements. Unfortunately, the custom or nontraditional toilets are often just modifications of the conventional design, such as the lower profile toilet which simply reduces the height of the toilet tank.

What would be beneficial is a toilet that has a completely different structural appearance, there is no reason a toilet cannot be built in this manner. An example of a new design toilet would be to build a toilet that has the appearance an animal, or specifically, an animal head and neck as an enclosure for a conventional toilet tank a toilet with the appearance of an animal would be a significant departure from the typical round bowl and rectangular tank design. By providing an option to choose from a variety of animals, a toilet could be provided that offers people a completely new and unique way of decorating a location that until now has been costly utilitarian.

A search of the prior art did not disclose any literature or patents that read directly on the claims of the instant invention. However, the following U.S. patents are considered related:

| PATENT NO. | INVENTOR | ISSUED |
|---|---|---|
| 3,805,304 | Ikehata | Apr. 23, 1974 |
| 6,016,576 | Happe | Jan. 25, 2000 |

The U.S. Pat. No. 3,805,304 patent discloses a ventilating toilet that is formed with a toilet bowl for exhausting objectionable odors therefrom. An air exhaust conduit rings the toilet opening and an air exhaust fan interconnects the conduit with a discharge conduit. A floor mounted switch assures automatic operation of the air exhaust fan to achieve the ventilating feature during either standing or seated toilet usage.

The U.S. Pat. No. 6,016,576 patent discloses a system for removing odorous vapors from a commode which comprises a modified toilet seat and hinge arrangement including a vacuum inducing fan arrangement. The invention uses a switch that is isolated form the power supply to a fan so only 12 volts DC electricity and 300 milliamps of current is transmitted through the switch wiring within the toilet seat.

For background purposes and indicative of the art to which the invention relates, reference may be made to the following remaining patents found in the patent search.

| PATENT NO. | INVENTOR | ISSUED |
|---|---|---|
| D337,486 | Maggiore | Jul. 20, 1993 |
| D412,071 | Grandis, Jr. | Jul. 20, 1999 |
| 7,797,766 | Ellinger | Sep. 21, 2010 |
| 9,440,129 | Gaerian | Sep. 13, 2016 |
| 2014/0090160 | MyBurgh | Apr. 3, 2014 |

### DISCLOSURE OF THE INVENTION

An animal design toilet (ADT) that optimally also includes odor reduction capability. The ADT has a base section with an interior, an outer surface, a bowl, an exit tube extending from the bowl and then out from a lower location on the base, and a plumbing interface that connects the exit tube to a utility waste removal pipe. Extending upward from the base, behind the bowl is an upper section with an animal structure design that has the appearance of an animal head, which can also include an animal neck and upper body, depending on the specific animal. The animal structure has an interior and attachment means for securing the upper section onto the base. Located within the interior of the upper section is a toilet tank that maintains a quantity of water that enters the bowl after each time the ADT is flushed an access panel on the rear of the upper section provides access to the interior of the upper section for cleaning and service/repair.

A flush actuator on the upper section is connected to a flush mechanism within the ADT. The actuator and mechanism facilitate the flush operation of the ADT, which is the same as other conventional toilets.

The base section and upper section can both be made of porcelain, but depending on the requirements of the animal design, that is used, the upper section/animal structure can also be made of plastic, metal, fiberglass or a composite material. The actual animal design can be chosen from a variety of animals including, but not limited to: a wolf, a dog, a horse, a domestic cat, a large cat, a squirrel, as snake, a giraffe, a fox, or other mammals.

The odor reduction assembly is located within the ADT, and is connected to the toilet bowl. The assembly has a discharge valve extending from the bowl and connected to the exit tube. In addition to facilitating the reduction/removal of odor, the discharge valve also removes noise from water flowing through the exit tube. A vacuum motor is connected to a fan blade that is in-line with the valve and exit tube. The motor causes the blade to rotate, which pulls odor into the valve and exit tube a power supply, which is preferably a battery but could also be utility main power, cause the motor to operate. An on/off switch reduction assembly is operational.

Optionally, the animal structure can have illuminated eyes and/or sound emitting from the structure. A proximately sensor actuator the eye lights and sound when a person conies within a certain distance from the ADT.

In view of the above disclosure, the primary object of the invention is to provide an animal design toilet with odor reduction capability that can be used as an alternating to the common toilet designs that are typically utilized.

In addition to the primary object, it is also an object of the invention to provide an animal design toilet with odor reduction capability that:
can be easily used in place of a conventional toilet,
   does not require special service or use,
   can come in a variety of colors, or even include fur/hair,
   is easy to operate,
   provides visual and audio enjoyment,
   is not significantly more expensive to produce,
   is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPION OF THE DRAWINGS

FIG. 1 is an orthographic view of an animal design toilet having the appearance of a wolf and including the upper body and lower body.

FIG. 2 is a front view of the animal design toilet.

FIG. 3 is a rear view of the animal design toilet.

FIG. 4 is a right side elevational view of the animal design toilet.

FIG. 5 is a left side elevational view of the animal design toilet.

FIG. 6 is a bottom view of the animal design toilet.

FIG. 7 is a top view of the animal design toilet.

FIG. 8 is an orthographic view of the animal design toilet having a wolf's upper body on a base section.

FIG. 9 is a right side view of the animal design toilet having a wolf's upper body on a base section.

FIG. 10 is a left side view of the animal design toilet having a wolf's upper body on a base section.

FIG. 11 is an orthography view of the animal design toilet showing internal elements including a flush mechanism motor on a motor mount, a battery on battery mount, and an exit tube.

### BEST MODE FOR CARRYING OUT THE INVENTION

The best mode for carrying out the invention is presented in terms that disclose a first embodiment and a second embodiment of an animal design toilet. In developed countries the toilet is one of the most widely used fixtures in homes, offices, retail establishments and any other location where people live, work or congregate. The basic design and appearance of a toilet has remained constant for a long time. The reason for this is because the design and appearance is effective, so there is no reason to change. For most people this status quo is fine since a toilet is viewed as a utilitarian device. As long as a toilet performs its function there is no need to alter anything, especially the appearance. For other people though, there is a distant desire and/or need to use a toilet with a different or custom appearance. In response to this there have been attempts to create toilets with different appearance. For some reason these attempts have not produced results that could be considered significant.

The animal design toilet (ADT) 10, does address this problem by providing a toilet that has the design/appearance of a selected animal. This animal appearance changes the toilet from being a simple utilitarian device into what is effectively a work of art which will add a major alteration or improvement to a bathroom. By using the ADT 10 a person, family or business will be able to add a custom and personalized aspect to their bathroom(s), an aspect that reflects their individual taste or add a thematic effect to a bathroom location.

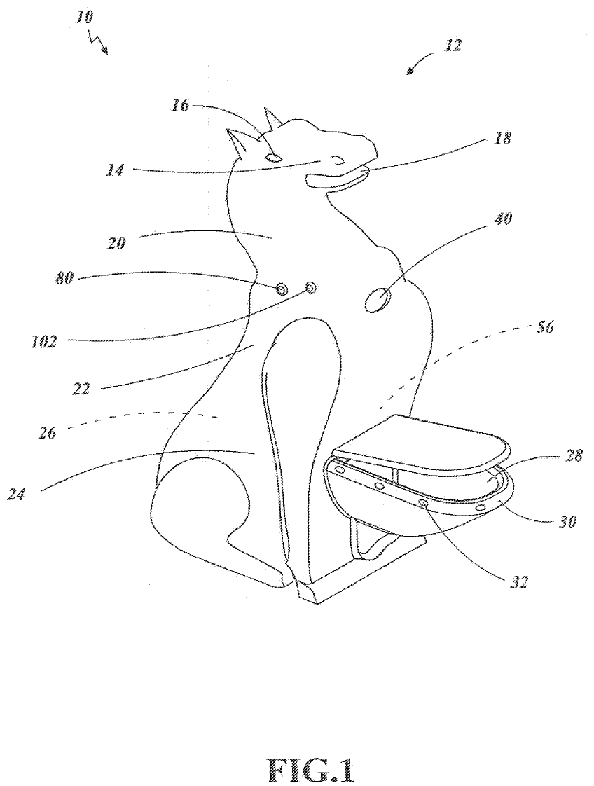

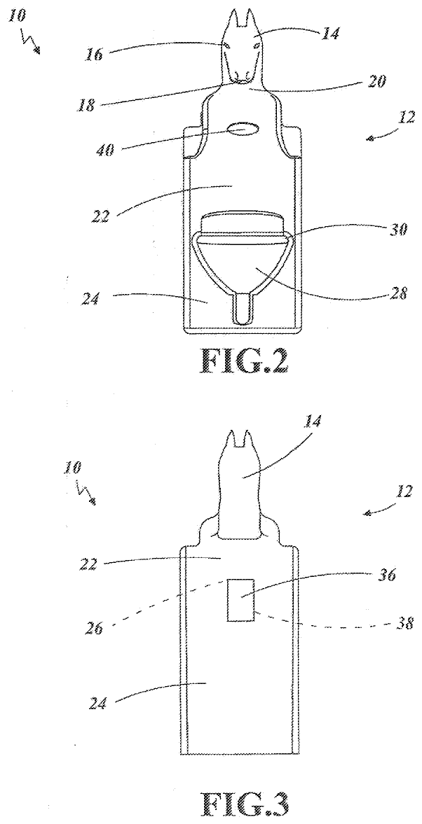

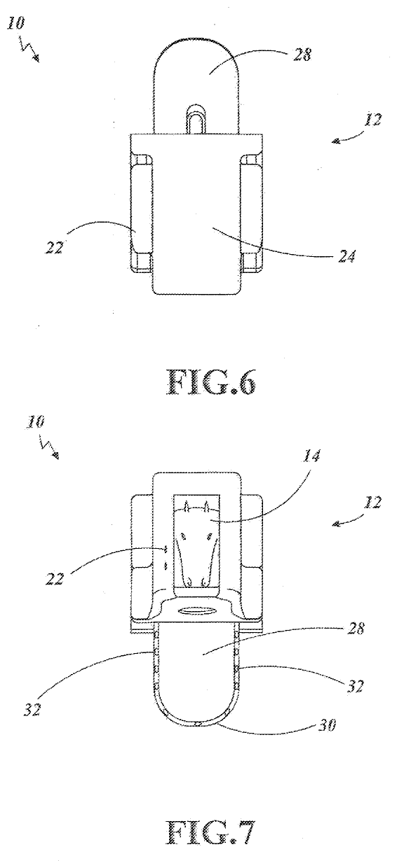

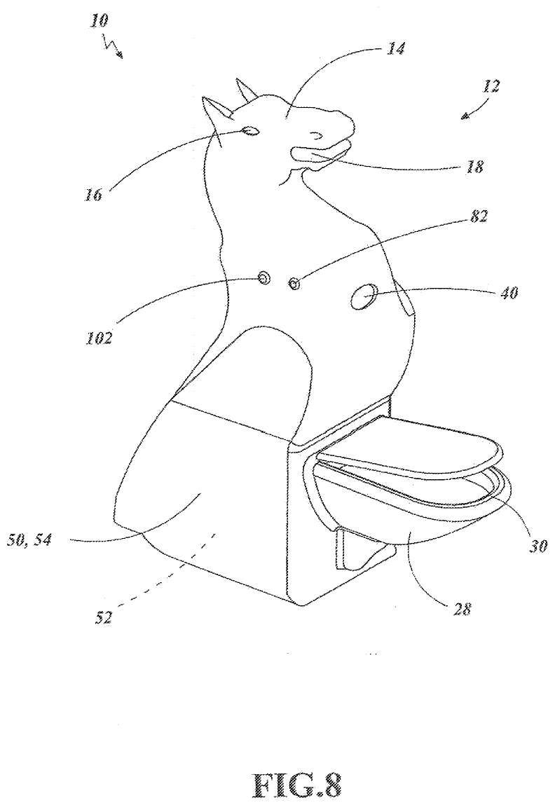

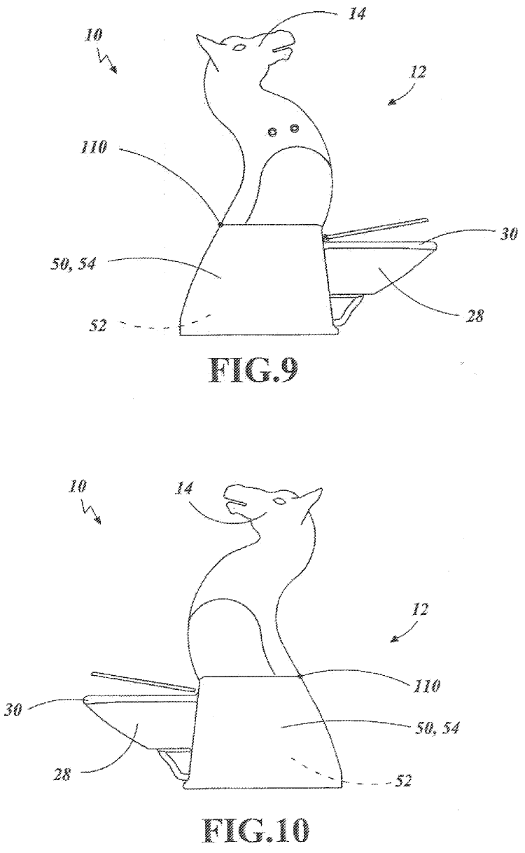

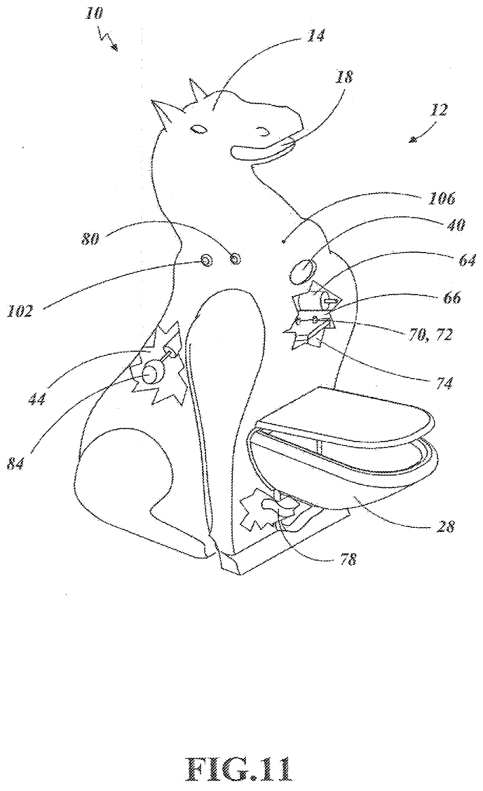

There are two structure designs of the ADT 10. Each design is determined by the type of animal selected. Some animals have a physiology that allows the animal's entire body, specifically the upper body and lower body, to be modified and utilized as a toilet. An example of this is when a wolf's entire body is used, as shown in FIGS. 1-11, alternately, other animal's or circumstances require that only the animal's upper body is used. As shown in FIGS. 8-10, the wolf's upper body is attached onto and extends upward from a base structure. When base is used, the animal's upper body is either a separate piece that is secured onto the base by means such as nuts/bolts, screws or other similar articles, on the base and upper body are a single, piece, integral structure when the upper body is separate piece, the upper body can be attached by a hinge that allows the upper body to be angularly raised or lowered from the base. This helpful in producing the ability to view and/or otherwise accept the internal components of the ADT 10.

The first embodiment and second embodiment have the same functionality and utilize all of the same elements between them. The first embodiment which has both the animal's upper body and lower body is shown in FIGS. 1-7. It should be noted that for the purpose of this disclosure a wolf is represented/shown as the animal for both embodiments. The actual animal that is used can be selected from a large variety of animals, for example of a wolf, a dog, a horse, a domestic cat, a large cat, a squirrel, a snake, a giraffe, a fox, and other mammals Also, the animal body and base can be made from various material including porcelain as used for many conventional toilets, plastic, metal, fiberglass or a composite material. The choice of material used determined by the desire/requirement of the application and the type of animal that is used.

The first embodiment of the ADT 10 are comprised of an animal structure 12 with a head 14 having eyes 16, a mouth 18, a neck 20 and both an upper body 22 and a lower body 24 located within the animal structure 12 is an interior 26 that houses all of the operational components of the ADT 10. Located on a rear area of the animal structure is an access panel 36 that is attached by a hinge which allows the panel to swing open. The access panel 36 provides easy access to the interior of the ADT 10 for inspection or repair. To provide a tight secure seal when the access panel 36 is closed, a gasket 38 can be placed around the panel to interface with the ACT 10.

Extending outward from the front of the lower body 24 is the toilet bowl 28 with a rim 30, as shown in FIG. 1,2 4, 5, 7-11. The bowl is preferably integrally attached to the animal body structure 12 and allows a person to easily and comfortably sit without any interference from the animal structure 12. Located within the animal structure 12 interior 26 are the functional components of the toilet, including a toilet tank 34 that receives and maintains a quantity of clean water that flows into the bowl when waste water exits after each flush of the ADT 10, a flush mechanism 42 that includes a floater assembly and is a common component of all toilets. An exit tube 44 allows the flushed waste water to be required from the ADT 10, and a plumbing interface 46 connects the exit tube 44 to the utility/city sewage system plumbing. A flush actuator 40 located on the exterior of the ADT 10 causes the flush mechanism 42 to engage and the ADT 10 to function as a typical toilet.

As previous, disclosed many different types of animals can be used for the ADT 10. In addition, the color(s) of the animals can be accurate to the type of animal or other features could be added to approximate the real appearance of the animal such as teeth or even hair/fur on the exterior of the animal. None of these would interfere with the operation of the ADT 10, so all are possible.

For the second embodiment of the ADT 10, the animal's lower body 24 is replaced with a base section 50, as shown in FIGS. 8-10. The base section 50 has an interior 52 to enclose the ADT's functional components, and other surface. The base section 50 can have any dimensions, which are typically determined by the use, location or space availability to place the ADT. Typically, the base section 50 will have the shape and size of a conventional toilet's lower section.

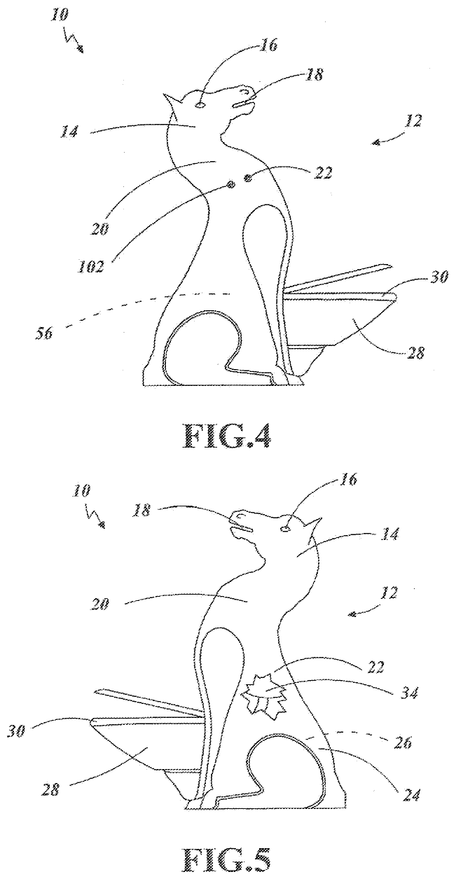

To increase the functionality of the ADT 10, an odor reduction assembly (ORA) 56 can be utilized. As shown in FIGS. 1 and 4, the ORA 56 functions with a plurality of openings 32 that circumvent the rim 30 on the toilet bow 28. Odor passes into the openings 32 and out through a discharge valve 58. To an odor escape tube 60. A fan blade 63 is located in-line with the valve 58 and escape tube 60. The fan pulls the odor out and through the openings the valve and tube. The fan 62 is powered by a vacuum motor 64 that preferably is secured on a motor mount within the ADT 10, as shown in FIG. 11. A power supply 70 provides the necessary power to operate the motor 64. The power 70 is preferably comprised of a battery 72 which also is secured on a battery mount 74 within the ADT 10, as also shown in FIG. 11. Alternately, the power could be supplied from a utility main power source (i.e., a wall plug) via a conventional, attached power cable or a removable IEC (or other) power cable. An ORA exit tube 78 can interface with the other exit tube 44 that is connected to the toilet bowl 28 to remove the odor along with the waste water. The ORA 56 can either always be on and function each time the ADT is flushed, or an on/off switch 80, as shown in FIGS. 11, 4, 8, and 9, located on the exterior of the ADT 10 will allow a person to selectively decide where the ORA 56 is necessary and should be turned “on”.

To add to the effect and/or realism of the animal structure 12 an eye light 86 and/or sound assembly can be utilized. The eye light 86 causes an eye on the animal structure to illuminate, the eye light operated by an electronic control circuit located within the upper section, the eye light automatically actuated after each flush of the ADT on the eye light actuated via an on/off switch 102, as shown in FIGS. 1, 4, 8 amd 9, connected to the eye.

The sound assembly 88 includes a recorded sound file, a playback device and s speaker, the sound assembly providing audible sound that replicates the sound made by the animal represented by the animal structure, the sound assembly operated by an electronic control circuit located within the upper section, wherein the sound assembly is automatically actuated after each flush of the ADT, or the sound assembly is actuated via an on/off switch connected to the ECC.

In conclusion, the ADT 10 with the ORA 56 can be especially beneficial to the environment in that unpleasant odor that would be present in any public or private bathroom, and would by necessity be smelled and inhaled by a person, is reduced. This is a significant improvement to the overall hygienic condition of a bathroom and could result in people being less exposed to potentially dangerous bacteria as well as foul odor.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. An animal design toilet (ADT) comprising:
a base section with:
an interior,
an outer surface,
a bowl that extends forwards from the base and includes,
a rim, the rim having a plurality of opening circumventing the rim,
an exit tube extending from the bowl and out from a lower location on the base,
a plumbing interface that connects the exit tube to a utility waste removal pipe,
an animal structure having the appearance of an animal, the animal structure extending upward from the base and including:
a head,
a neck,
an upper body,
an interior,
attachment means for securing the animal structure onto an upper rear area of the base,
a toilet tank located within the interior of the ADT, the tank maintaining a quantity of water that enters the bowl after each time the ADT is flushed,
an access panel that provides access to the upper section interior, the access panel having a gasket to provide a seal when the panel is in a closed position,
a flush actuator on the upper section, the actuator is connected to a flush mechanism located within the upper section interior, the actuator and the mechanism causing waste water in the bowl to be removed from the bowl via an exit tube, replacement water to enter the bowl from the tank, and new water to enter the tank.

2. The animal design toilet of claim 1 wherein the base section is made of porcelain.

3. The animal design toilet of claim 1 wherein the base has the appearance of the animal's lower body which is integrally attached to and continues from the animal's upper body.

4. The animal design toilet of claim 1 wherein the animal structure has the appearance of an animal selected from the group consisting of a wolf, a dog, a horse, a domestic cat, a large cat, a squirrel, a snake, a giraffe, a fox, and other mammals.

5. The animal design toilet of claim 1 wherein the animal structure is made of a material selected from the group consisting of porcelain, plastic, metal, fiberglass, and composite material.

6. The animal design toilet of claim 1 further comprising an eye light that causes an eye on the animal structure to illuminate, the eye light operated by an electronic control circuit located within the upper section, the eye light automatically actuated after each flush of the ADT on the eye light actuated via an on/off switch connected to the eye.

7. The animal design toilet of claim 1 further comprising a sound assembly including a recorded sound file, a playback device and s speaker, the sound assembly providing audible sound that replicates the sound made by the animal represented by the animal structure, the sound assembly operated by an electronic control circuit located within the upper section, wherein the sound assembly is automatically actuated after each flush of the ADT, or the sound assembly is actuated via an on/off switch connected to the ECC.

8. The animal design toilet of claim 1 further comprising a proximity sensor that actuates the eye light and sound assembly when a person comes within a certain distance of the ADT.

9. An animal design toilet comprising:
a base section with:
an interior
an outer surface,
a bowl that extends forward from the base and includes,
a rim, the rim having a plurality of openings circumventing the rim,
an exit tube extending from the openings on the bowl rim and out from a lower location on the base,
a plumbing interface that connects the exit tube to a utility waste removal pipe,
an animal structure having the appearance of an animal, the animal structure extending upward from the base and including:
a head,
a neck,
an upper body,
an interior,
attachment means for securing the upper section onto an upper rear area of the base,
a toilet tank located within the interior of the upper section, the tank maintaining a quantity of water that enters the bowl after each time the ADT is flushed,
an access panel that provides access to the upper section interior, the access panel having a gasket to provide a seal when the panel is in a closed position,
a flush actuator on the upper section, the actuator is connected to a flush mechanism located within the upper section interior, the actuator and the mechanism causing waste water in the bowl to be removed from the bowl via an exit tube, replacement water to enter the bowl from the tank, and new water to enter the tank,
an odor reduction assembly that is located within the ADT, and is connected to the toilet bowl, the assembly comprising:
a discharge valve extending outward from the toilet bowl and connected to the waste water exit tube,
a fan blade that is located in-line with the valve and exit tube, and rotates to provide suction, which pulls odors from the bowl, into the discharge valve and exit tube, thereby removing odor with the waste water from the ADT,
a vacuum motor that is supported on a motor mount within the ADT the motor providing power that causes the fan blade to rotate,
a power supply comprising a batter that is supported on a battery mount within the ADT, the battery supplying power to the motor,
a power on/off switch that is connected to the power supply and allows a person to selectively choose if the odor reduction assembly is actuated after each flush, or is not actuated after each flush.

10. The animal design toilet of claim 9 wherein the base section is made of porcelain.

11. The animal design toilet of claim 9 wherein the base has the appearance of the animal's lower body which is integrally attached to and continues from the animal's upper body.

12. The animal design toilet of claim 9 wherein the animal structure has the appearance of an animal selected from the group consisting of a wolf, a dog, a horse, a domestic cat, a large cat, a squirrel, a snake, a giraffe, a fox, and other mammals.

13. The animal design toilet of claim 9 wherein the animal structure is made of a material selected from the group consisting of porcelain, plastic, metal, fiberglass, and composite material.

14. The animal design toilet of claim 9 further comprising an eye light that causes an eye on the animal structure to illuminate, the eye light operated by an electronic control circuit located within the upper section, the eye light automatically actuated after each flush of the ADT or the eye light actuated via an on/off switch connected to the eye.

15. The animal design toilet of claim 9 further comprising a sound assembly including a recorded sound file, a playback device and a speaker, the sound assembly providing audible sound that replicates the sound made by the animal represented by the animal structure, the sound assembly operated by an electronic control circuit (ECC) located within the upper section, wherein the sound assembly is automatically actuated after each flush of the ADT, or the sound assembly is actuated via an on/off switch connected to the ECC.

16. The animal design toilet of claim 9 further comprising a proximity sensor that actuates the eye light and sound assembly when a person comes within a certain distance of the ADT.

17. The animal design toilet of claim 9 wherein the discharge valve reduces noise emitting from waste water flowing through the exit tube.

18. The animal design toilet of claim 9 wherein the odor reduction assembly is located within the ADT.

19. The animal design toilet of claim 9 further comprising a hinge that is located at a rear section of the ADT where the upper section interfaces with the base section the hinge allowing the upper section to be tilted backward from the base.

20. The animal design toilet of claim 9 wherein the upper section is integrally attached to the base section.
